(19) United States
(12) Patent Application Publication
(10) Pub. No.: US 2011/0052958 A1
(43) Pub. Date: Mar. 3, 2011

(54) BATTERY HOLDER AND ELECTRICAL DEVICE HAVING THEREOF

(75) Inventor: Chia-Chi Tang, Tantz Shiang (TW)

(73) Assignee: Asia Optical Co., Inc., Tantz Shiang (TW)

(21) Appl. No.: 12/550,496

(22) Filed: Aug. 31, 2009

(51) Int. Cl. H01M 2/10

(52) U.S. Cl. 429/100

(57) ABSTRACT

A battery holder is provided for supplying electrical power to a battery operated electrical device. The battery holder includes a main fixing frame, a spare fixing frame and a battery cover. The main fixing frame defines a first opening and a first battery-receiving cavity for receiving at least one main battery. The spare fixing frame is assembled onto the main fixing frame for closing the first opening of the main fixing frame. The spare fixing frame defines a second opening and a second battery-receiving cavity for receiving at least one spare battery that can be removed from the second battery-receiving cavity to the first battery-receiving cavity for replacing the main battery. A battery cover is assembled onto the spare fixing frame for closing the second opening of the spare fixing frame.

### BACKGROUND OF THE INVENTION

1. Field of the Invention

The present invention relates to a battery holder, and more particularly to a battery holder with a main battery and a spare battery received therein, and to a battery holder for a battery operated electrical device such as a rangefinder and a laser sighting apparatus.

2. Description of the Prior Art

Batteries have found versatile ways of applications in electrical devices in situations where mains electricity is inappropriate, especially for portable electrical devices, such as a rangefinder, a laser sighting apparatus and the likes.

FIGS. 1-3 of the attached drawings show schematic views of a known battery operated electrical device, generally designated at 9. As shown in FIGS. 1-3, the known battery operated electrical device 9 has a housing 90 and a battery holder 92 with at least one battery 94 received therein. The battery holder 92 includes an insulating frame 920 formed on the top of the housing 90. The insulating frame 920 forms one battery-receiving cavity 922 for receiving the battery 94 and for receiving conductive components 96 that electrically contact with the battery 94. The battery holder 92 further includes a battery cover 98 for enclosing the battery-receiving cavity 922 and being removable from the fixing frame 920 for replacing the battery 94.

The currently available battery operated electrical devices are often subjected to constraint of the operable time period of the battery that supplies electrical power to support their operations. For example, when the battery being used in the electrical device is dead or become exhausted, a user must leave to get a replacement battery in order to continue the operation of the electrical device. To facilitate changing the battery, the spare batteries are generally placed in the user's pockets. However, because the batteries used for such electrical devices are relatively small, it is often that they get lost or get dirty or affected with damps. These problems are troublesome to the users of the battery operated electrical devices.

Accordingly, it is desirable to provide a battery operated electrical device having a battery holder with a main battery and a spare battery received therein in order overcome the above problems.

### BRIEF SUMMARY OF THE INVENTION

An object of the present invention is to provide a battery holder that stores at least one main battery and one spare battery, so that the spare battery can easily and timely replace the main battery when the main battery becomes exhausted.

Another object of the present invention is to provide an electrical device having a battery holder with at least one main battery and one spare battery received therein, whereby the main battery, when exhausted, can be easily and timely replaced by the spare battery.

To achieve the above objects, in accordance with the present invention, a battery holder is provided for accommodating electrical batteries to supply electrical power to a battery operated electrical device. The battery holder comprises a main fixing frame defining a first opening and a first battery-receiving cavity for receiving at least one main battery, a spare fixing frame assembled onto the main fixing frame for closing the first opening of the main fixing frame and defining a second opening and a second battery-receiving cavity for receiving at least one spare battery that is removable from the second battery-receiving cavity to be receivable into the first battery-receiving cavity for replacing the main battery, and a battery cover assembled onto the spare fixing frame for closing the second opening of the spare fixing frame.

In one embodiment, the battery holder further comprises a first insulating sheet located on a bottom surface of the spare battery for separating the spare battery from the main battery and a second insulating sheet located on an upper surface of the spare battery.

In one embodiment, the spare fixing frame has an extending portion insertable into the main fixing frame for fixing the spare fixing frame to the main fixing frame, and an L-shaped spring member, which is disposed on an outer bottom of the spare fixing frame for applying a pressure to the main battery.

In one embodiment, the main fixing frame further defines an element-receiving cavity, which is adjacent to the first battery-receiving cavity and receives a number of conductive components.

In one embodiment, the conductive components comprise a circuit board having flexible spring fingers mounted thereon, and a conductive board located upon the circuit board and having a center conductive portion for electrically connecting the main battery and the flexible spring fingers.

In one embodiment, the center conductive portion of the conductive board has an upper surface in direct contact with the bottom surface of the main battery and a bottom surface in direct contact with the flexible spring fingers.

In one embodiment, the conductive components comprise a circuit-board-fixing sheet located on the circuit board for fixing the circuit board to an inner bottom of the main fixing frame, and a conductive-board-fixing ring located on the conductive board.

In one embodiment, the battery holder further comprises a battery-retaining ring, which is arranged in the first battery-receiving cavity of the main fixing frame and defines a cylindrical retaining cavity for receiving and retaining the main battery.

In one embodiment, the cylindrical retaining cavity has a wall in contact with a side surface of the main battery, the battery-retaining ring having a bottom surface in contact with the conductive-board-fixing ring.

In accordance with another aspect of the present invention, an electrical device operated by at least one battery is provided. The electrical device comprises a housing, a main fixing frame, which is disposed on the housing and defines a first opening and a first battery-receiving cavity for receiving at least one main battery; a spare fixing frame, which is assembled onto the main fixing frame for closing the first opening of the main fixing frame and defines a second opening and a second battery-receiving cavity for receiving at least one spare battery that is removable from the second battery-receiving cavity to be receivable into the first battery-receiving cavity for replacing the main battery when the main battery becomes exhausted, and a battery cover, which is assembled onto the spare fixing frame for closing the second opening of the spare fixing frame.

In comparison with the prior art, the battery holder according to the present invention comprises a spare fixing frame and at least one spare battery received therein, so that the spare battery can be easily and timely removed from the second battery-receiving cavity of the spare fixing frame to be put into the first battery-receiving cavity of the main fixing frame in order to replace the main battery as the power when the main battery becomes exhausted.

### BRIEF DESCRIPTION OF THE DRAWINGS

The present invention may best be understood through the following description with reference to the accompanying drawings, in which:

FIG. 1 is a perspective view showing a conventional battery operated electrical device;

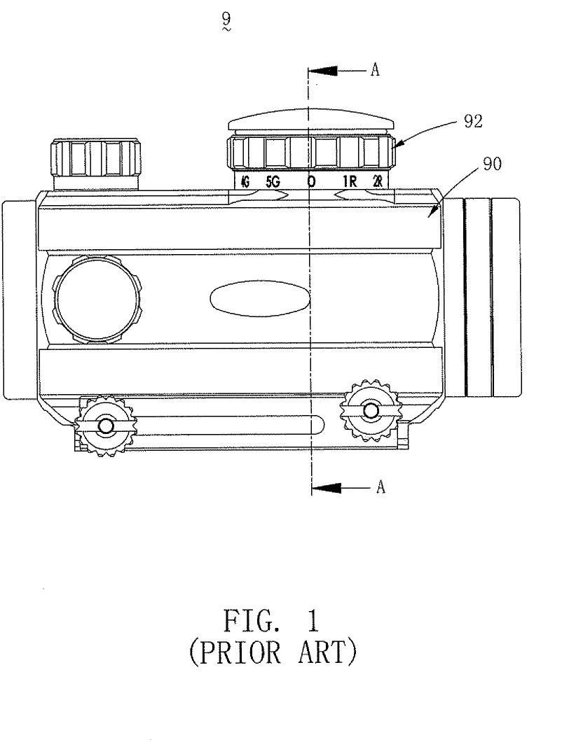

FIG. 2 is a cross-sectional view taken along line A-A of FIG. 1, showing inside structure of a battery holder of the conventional battery operated electrical device;

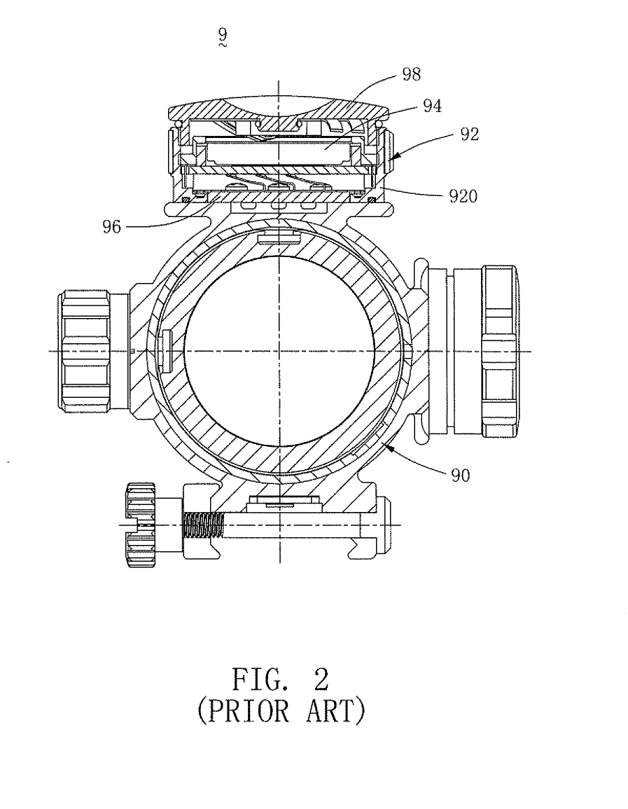

FIG. 3 is an exploded section view of the conventional battery operated electrical device shown in FIG. 2;

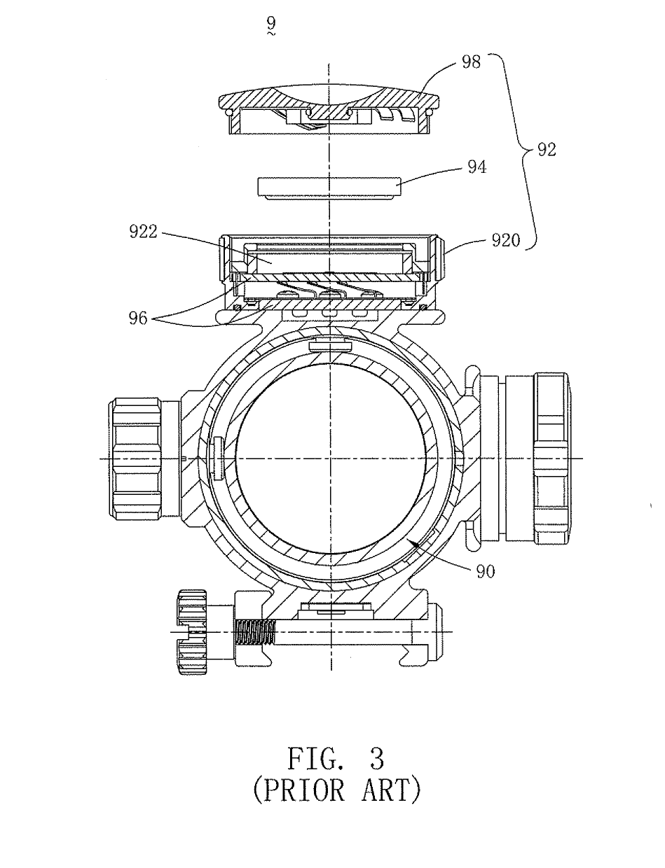

FIG. 4 is a perspective view showing an electrical device in accordance with the present invention;

FIG. 5 is a cross-sectional view taken along line B-B of FIG. 4, showing inside structure of a battery holder formed on the electrical device in accordance with the present invention;

FIG. 6 is an exploded perspective view of the electrical device of the present invention shown in FIG. 4; and

FIG. 7 is an exploded section view of the electrical device of the present invention shown in FIG. 5.

### DETAILED DESCRIPTION OF THE PREFERRED EMBODIMENTS

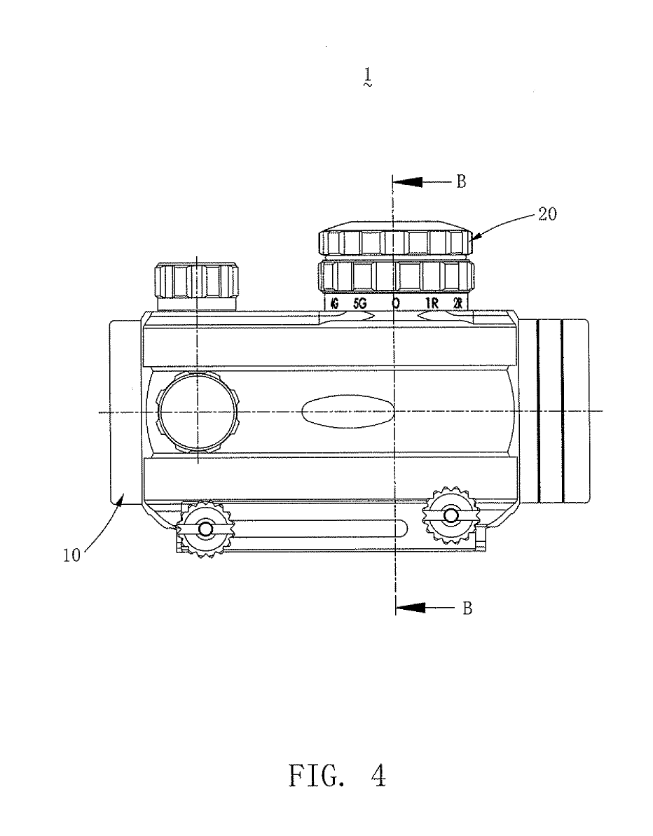

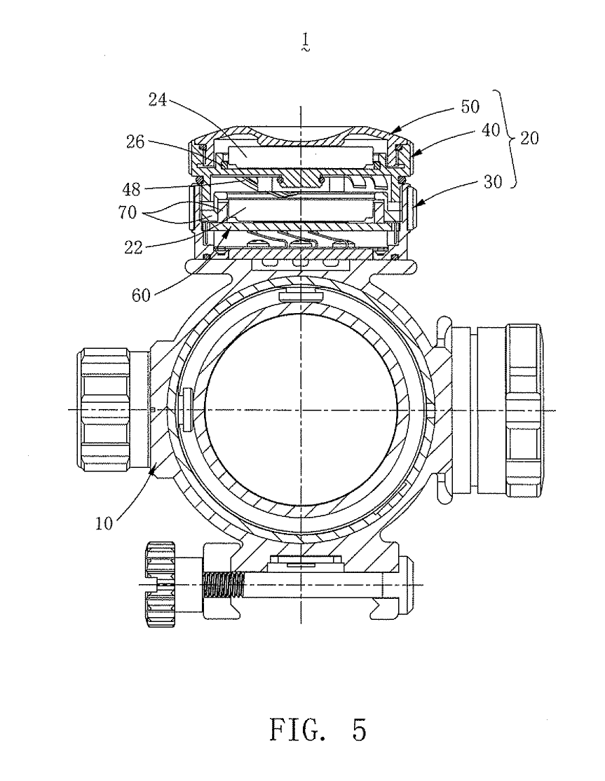

With reference to the drawings and in particular to FIG. 4, which is a perspective view showing an electrical device I according to an embodiment of the present invention, and FIG. 5, which shows inside structure of a battery holder 20 incorporated in the electrical device 1 in accordance with the present invention, the electrical device 1 is operated by at least one battery and comprises a housing 10 and a battery holder 20, which receives therein at least one main battery 22 and one spare battery 24 received therein. In one preferred embodiment, the main battery 22 and the spare battery 24 are button-type cells, and the battery operated electrical device 1 may be a rangefinder or a laser sighting apparatus.

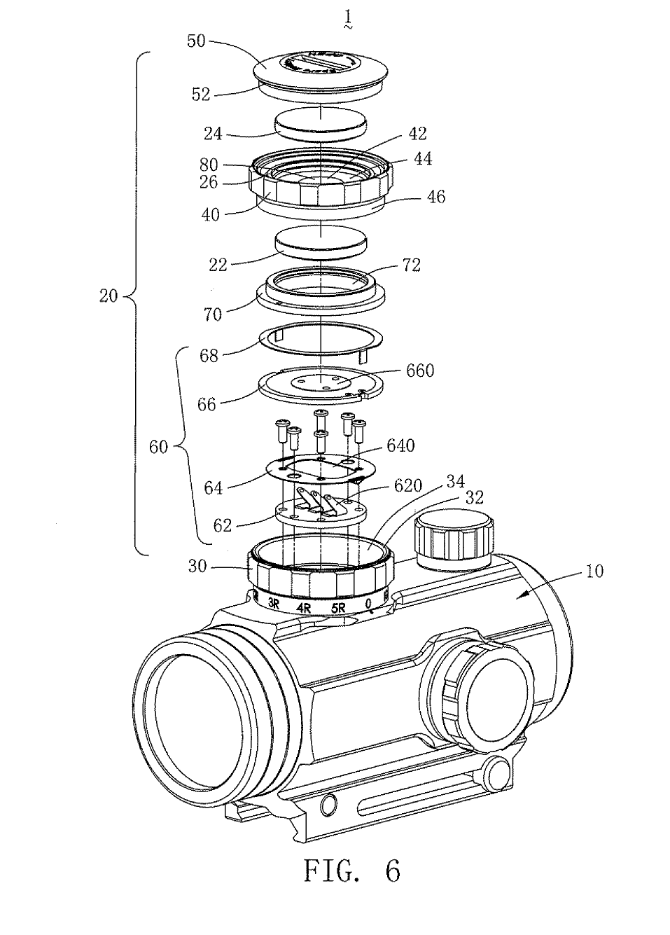

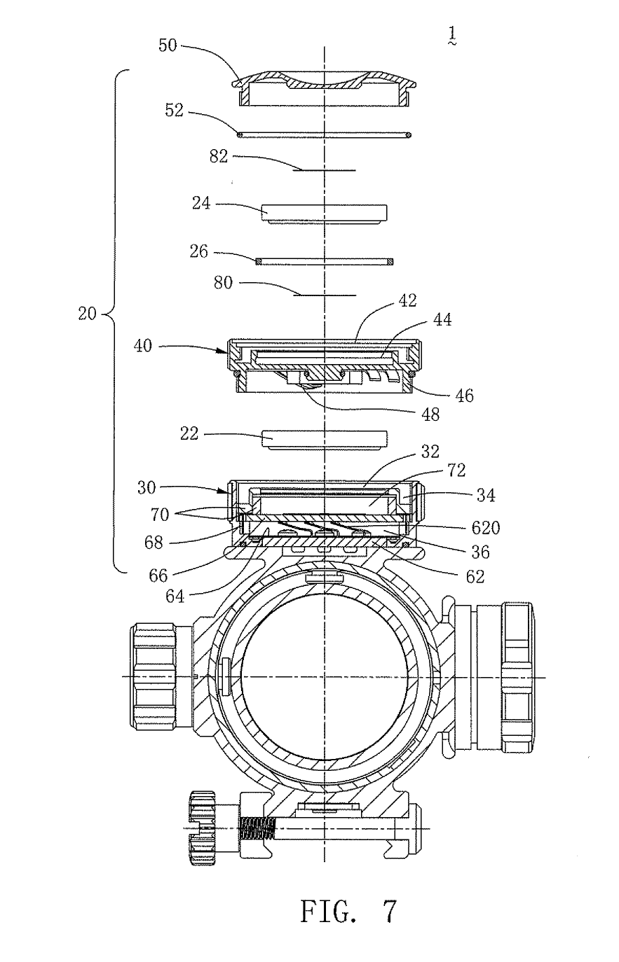

Referring to FIG. 6, which is an exploded perspective view of the electrical device 1, and FIG. 7, which is an exploded section view of the electrical device 1, the battery holder 20 is disposed on the housing 10 of the electrical device 1. The battery holder 20 comprises a main fixing frame 30 located on the housing 10, a spare fixing frame 40 assembled onto the main fixing frame 30, and a battery cover 50 assembled onto the spare fixing frame 40.

In one embodiment, the main fixing frame 30 defines a first opening 32, a first battery-receiving cavity 34 for receiving at least one main battery 22, and an element-receiving cavity 36 adjacent to the first battery-receiving cavity 34 for receiving a number of conductive components 60. The main battery 22 is receivable into the battery-receiving cavity 34 through the first opening 32 to provide electrical power to the electrical device 1.

The conductive components 60 received in the element-receiving cavity 36 are adjacent to the first battery-receiving cavity 34 and are set in electrically engagement with the main battery 22. In detailed words, the conductive components 60 comprise a circuit board 62 located on the bottom of the element-receiving cavity 36, a circuit-board-fixing sheet 64 located on the circuit board 62, a conductive board 66 located above the circuit board 62 and the circuit-board-fixing sheet 64, and a conductive-board-fixing ring 68 located on the conductive board 66. The circuit board 62 has three flexible spring fingers 620 mounted thereon. The three flexible spring fingers 620 extend through a center hole 640 of the circuit-board-fixing sheet 64 to electrically engage a center conductive portion 660 of the conductive board 66. The upper surface of the center conductive portion 660 of the conductive board 66 directly contacts the bottom surface of the main battery 22 and the bottom surface of the center conductive portion 660 directly contacts the flexible spring fingers 620, so that the center conductive portion 660 electrically connects the main battery 22 to the flexible spring fingers 620.

Also provided inside the main fixing frame 30 is a battery-retaining ring 70 that is set in the first battery-receiving cavity 34 and defines a cylindrical retaining cavity 72 for receiving and retaining the main battery 22. The cylindrical retaining cavity 72 has a wall in contact with a side surface of the main battery 22. The battery-retaining ring 70 has a bottom surface in contact with the conductive-board-fixing ring 68.

In one embodiment, the spare fixing frame 40, which functions to close the first opening 32 of the main fixing frame 30, defines a second opening 42 and a second battery-receiving cavity 44. At least one spare battery 24 is received in the second battery-receiving cavity 44 and can be removed out of the second battery-receiving cavity 44 and received into the first battery-receiving cavity 34 to replace the main battery 22 when the main battery 22 becomes exhausted. The spare fixing frame 40 has an extending portion 46 and an L-shaped spring member 48. The extending portion 46 is insertable into the main fixing frame 30 for fixing the spare fixing frame 40 to the main fixing frame 30, and the L-shaped spring member 48 is disposed on an outer bottom of the spare fixing frame 40 and presses the upper surface of the main battery 22 for application of pressure on the main battery 22. Moreover, a spare-battery-fixing ring 26 is also received in the second battery-receiving cavity 44 and is used for fixing the spare battery 24.

Inside the spare fixing frame 40, a first insulating sheet 80 and a second insulating sheet 82 are arranged. The first insulating sheet 80 is located on the bottom surface of the spare battery 24 for separating the spare battery 24 from the main battery 22. Namely, in one embodiment, the first insulating sheet 80 is disposed on the inner bottom of the second battery-receiving cavity 44 and is arranged between the main battery 22 and the spare battery 24. The second insulating sheet 82 is located on the upper surface of the spare battery 24 and is arranged between the spare battery 24 and the battery cover 50.

In one embodiment, the battery cover 50 is used for closing the second opening 42 of the spare fixing frame 40 to protect the spare battery 24. Preferably, a water-tight sealing ring 52 is arranged between the battery cover 50 and the spare fixing frame 40 for enhancing the sealing performance of the battery holder 20.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery holder adapted to be mounted to a housing of a battery operated electrical device, comprising:
a main fixing frame defining a first opening and a first battery-receiving cavity for receiving at least one main battery;
a spare fixing frame assembled onto the main fixing frame for closing the first opening of the main fixing frame and defining a second opening and a second battery-receiving cavity for receiving at least one spare battery that is removable from the second battery-receiving cavity to be received into the first battery-receiving cavity for replacing the main battery; and
a battery cover assembled onto the spare fixing frame for closing the second opening of the spare fixing frame.

2. The battery holder as claimed in claim 1 further comprising a first insulating sheet located on a bottom surface of the spare battery for separating the spare battery from the main battery and a second insulating sheet located on an upper surface of the spare battery.

3. The battery holder as claimed in claim 2, wherein the spare fixing frame has an extending portion insertable into the main fixing frame for fixing the spare fixing frame to the main fixing frame, and an L-shaped spring member, which is disposed on an outer bottom of the spare fixing frame for applying a pressure to the main battery.

4. The battery holder as claimed in claim 1 further comprising a number of conductive components adjacent to the first battery-receiving cavity in the main fixing frame for electrically contacting the main battery.

5. The battery holder as claimed in claim 4, wherein the main fixing frame defines an element-receiving cavity, which is adjacent to the first battery-receiving cavity and receives the conductive components.

6. The battery holder as claimed in claim 5, wherein the conductive components comprise a circuit board having flexible spring fingers mounted thereon, and a conductive board located upon the circuit board and having a center conductive portion for electrically connecting the main battery and the flexible spring fingers.

7. The battery holder as claimed in claim 6, wherein the center conductive portion of the conductive board has an upper surface in direct contact with the bottom surface of the main battery and a bottom surface in direct contact with the flexible spring fingers.

8. The battery holder as claimed in claim 7, wherein the conductive components comprise a circuit-board-fixing sheet located on the circuit board for fixing the circuit board to an inner bottom of the main fixing frame, and a conductive-board-fixing ring located on the conductive board.

9. The battery holder as claimed in claim 8 further comprising a battery-retaining ring, which is arranged in the first battery-receiving cavity of the main fixing frame and defines a cylindrical retaining cavity for receiving and retaining the main battery.

10. The battery holder as claimed in claim 9, wherein the cylindrical retaining cavity has a wall in contact with a side surface of the main battery, the battery-retaining ring having a bottom surface in contact with the conductive-board-fixing ring.

11. An electrical device operated by at least one battery, comprising:
a housing;
a main fixing frame, which is mounted to the housing and defines a first opening and a first battery-receiving cavity for receiving at least one main battery;
a spare fixing frame, which is assembled onto the main fixing frame for closing the first opening of the main fixing frame and defines a second opening and a second battery-receiving cavity for receiving at least one spare battery that is removable from the second battery-receiving cavity to be receivable into the first battery-receiving cavity for replacing the main battery when the main battery becomes exhausted; and
a battery cover, which is assembled onto the spare fixing frame for closing the second opening of the spare fixing frame.

12. The electrical device as claimed in claim 11, wherein a first insulating sheet is located on a bottom surface of the spare battery for separating the spare battery from the main battery and a second insulating sheet is located on an upper surface of the spare battery.

13. The electrical device as claimed in claim 11, wherein the spare fixing frame has an extending portion, which is insertable into the main fixing frame for fixing the spare fixing frame to the main fixing frame, and an L-shaped spring member, which is disposed on an outer bottom of the spare fixing frame for applying a pressure to the main battery.

14. The electrical device as claimed in claim 11, wherein a number of conductive components is set adjacent to the first battery-receiving cavity in the main fixing frame for electrically contacting with the main battery.

15. The electrical device as claimed in claim 14, wherein the main fixing frame defines an element-receiving cavity, which is adjacent to the first battery-receiving cavity and receives the conductive components.

16. The electrical device as claimed in claim 15, wherein the conductive components comprise a circuit board having flexible spring fingers mounted thereon, and a conductive board located upon the circuit board and having a center conductive portion for electrically connecting the main battery and the flexible spring fingers.

17. The electrical device as claimed in claim 16, wherein the center conductive portion of the conductive board has an upper surface in direct contact with the bottom surface of the main battery and a bottom surface in direct contact with the flexible spring fingers.

18. The electrical device as claimed in claim 17, wherein the conductive components comprise a circuit-board-fixing sheet located on the circuit board for fixing the circuit board to an inner bottom of the main fixing frame, and a conductive-board-fixing ring located on the conductive board.

19. The electrical device as claimed in claim 18, wherein a battery-retaining ring is arranged in the first battery-receiving cavity of the main fixing frame and defines a cylindrical retaining cavity for receiving and retaining the main battery.

20. The electrical device as claimed in claim 19, wherein the cylindrical retaining cavity has a wall in contact with a side surface of the main battery, the battery-retaining ring having a bottom surface in contact with the conductive-board-fixing ring.
